(19) United States
(12) Patent Application Publication
(10) Pub. No.: US 2004/0059785 A1
(43) Pub. Date: Mar. 25, 2004

(54) System and method for creating and managing persistent group representation for meetings

(76) Inventor: Leo R. Blume, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/251,874

(22) Filed: Sep. 23, 2002

(51) Int. Cl. G06F 15/16

(52) U.S. Cl. 709/206; 709/204

(57) ABSTRACT

A system and method for creating and managing electronic group representations for meetings uses a meeting memory manager (MMM) to collect and maintain important artifacts of meetings so that meeting participants can easily access the meeting artifacts. The group representation created by the MMM, i.e., the MMM meeting, is a persistent collective representation of the meeting participants, along with important artifacts associated with the meeting. Using the MMM meeting representation, a presenter or any meeting participant can send updated documents to other meeting participants by communicating with the group, without having to collect email addresses from the attendees or having to enter email addresses individually. Therefore, the MMM offers greater ease of communication with the meeting participants and less book keeping of email addresses and meeting documents.

### Technical Field

The technical field relates to computer software systems, and, in particular, to systems for creating and managing persistent group representations for meetings.

### BACKGROUND

Business and technical meetings range from formal arranged meetings in conference rooms to spontaneous encounters in hallways. During and after such meetings, meeting participants often use computers to exchange files, send emails, and/or deliver follow-up documents to one another. However, the laptop and handheld computers brought to meetings generally have little capacity for supporting these meetings. Specifically, the laptop and handheld computers lack a mechanism for creating persistent electronic representations of the meetings. Without such persistent representation, it is difficult to preserve the context of the meetings or to effectively extend the meetings through the exchange of follow-up emails and documents. For example, the meeting participants typically have to collect email addresses from all attendees and have to manually track the documents associated with a meeting for post-meeting communications.

### SUMMARY

A method for creating and managing persistent group representations for meetings includes establishing a meeting, which includes creating a meeting identification for a meeting and inviting and enrolling meeting participants for the meeting. The method further includes tracking meeting artifacts and managing searches and accesses of the meeting artifacts by the meeting participants. The meeting artifacts include meeting documents, and optionally meeting emails and recordings of meeting proceedings.

The method uses a meeting memory manager (MMM) to create and manage the persistent meeting representations. The MMM includes a meeting identification generator that generates the meeting identification and, in some implementations, tags the meeting artifacts with the meeting identification. The MMM also includes an enrollment and management facility that invites and enrolls the meeting participants. The MMM further includes a user interface that enables the meeting participants to search and access the meeting artifacts.

### DESCRIPTION OF THE DRAWINGS

The preferred embodiments of the method and apparatus for creating and managing persistent group representations for meetings will be described in detail with reference to the following figures, in which like numerals refer to like elements, and wherein:

FIG. 1 illustrates exemplary software components of a meeting memory manager (MMM) that creates and manages persistent representations for meetings;

FIG. 2 illustrates exemplary hardware components of a computer that may be used in connection with the MMM;

FIGS. 3 and 4 illustrate an exemplary procedure for initiating a MMM meeting by a user; and

FIGS. 5-8 are flow charts illustrating an exemplary method for creating and managing persistent group representations for meetings.

### DETAILED DESCRIPTION

Business and technical meetings may take a variety of forms. For example, the meetings may be formal events in conference rooms or casual hallway encounters. Described here is a system and method for creating and managing an electronic group representation for meetings using a software module, referred to as a meeting memory manager (MMM). The electronic group representation created by the MMM, i.e., the MMM meeting, is a persistent representation of meeting participants, along with important artifacts associated with the meeting. The MMM typically collects and maintains the meeting artifacts so that the meeting artifacts can be easily accessed by the meeting participants.

Using the MMM meeting representation, a presenter or any meeting participant can send updated documents to other meeting participants by communicating with the meeting group, without having to collect email addresses from the attendees or having to enter email addresses individually. For example, to email a document to all other meeting participants, one participant may send the email to a meeting-email-alias generated by the MMM for the meeting. Therefore, the MMM offers greater ease of communication with the meeting participants and less book keeping of email addresses and documents.

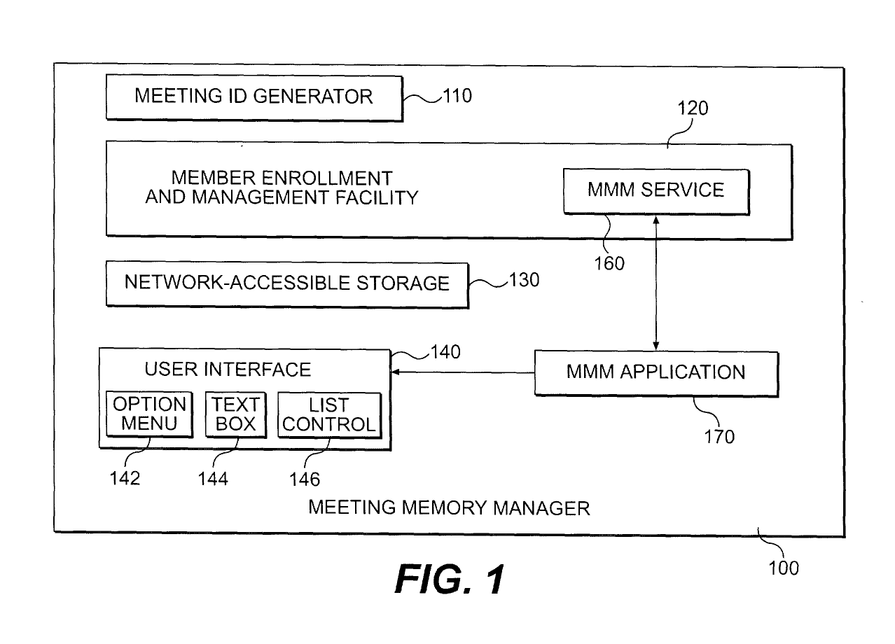

FIG. 1 illustrates exemplary software components of a MMM 100 that creates and manages persistent group representations for meetings. The MMM 100 includes a meeting identification generator 110 that generates an identification (ID) for a meeting and, in some implementations, tags meeting artifacts with the meeting ID. The MMM 100 uses a member enrollment and management facility 120 to invite and enroll meeting participants. The member enrollment and management facility 120 may include a MMM service 160, which typically runs as a background process on each computer that participates in the meetings managed by the MMM 100. The MMM service 160 typically interacts with other MMM services 160 on the other meeting participants' computers for initiating and managing the MMM meeting. The MMM service 160 typically idles in the background awaiting a notice or signal (described in detail later) to begin a meeting. The notice or signal may be initiated by a meeting participant (i.e., a user) or a computer.

The MMM 100 further uses a network-accessible storage 130 to store the meeting artifacts for the meeting participants. The meeting artifacts may include a list of meeting attendees, meeting-related documents that are shared at the meeting, email or file documents that are derived from the meeting-related documents, the time and location of the meeting, snapshots of whiteboards from the conference room, and audio/video records of the proceedings. The MMM 100 further includes a user interface (UI) 140 that enables the meeting participants to search, access and manipulate the meeting artifacts. The UI 140 may be created by a MMM application 170. The MMM application 170 may also interact with the MMM service 160 for initiating a MMM meeting. Until a MMM meeting is deleted, the MMM 100 manages and maintains the meeting artifacts for the meeting participants.

The MMM software typically runs on a network-connected computer. The software may be compiled for different computer systems in order that versions of the software may run in any electronic devices, such as a personal computer, a laptop computer, a personal digital assistant (PDA), or a cellular telephone.

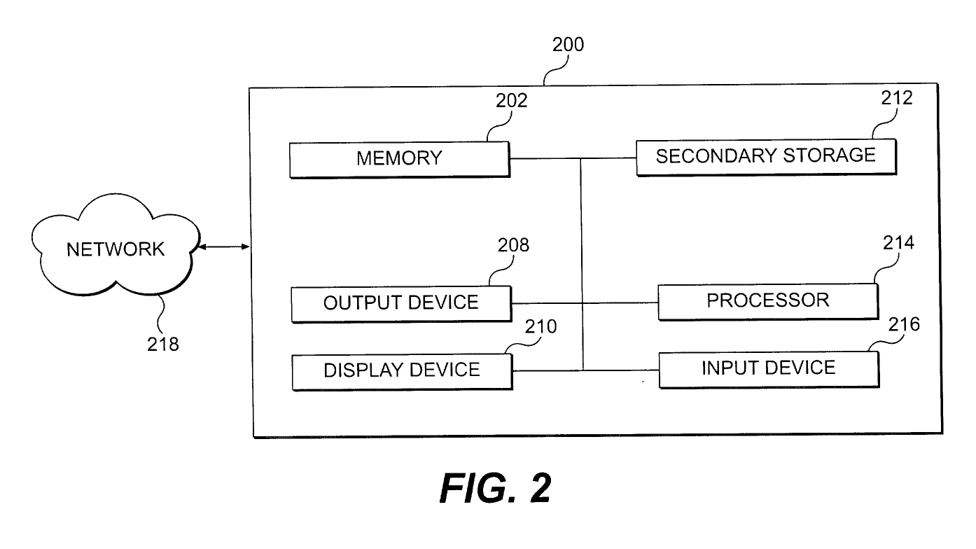

FIG. 2 illustrates exemplary hardware components of a computer 200 that may be used in connection with the MMM 100. The computer 200 includes a connection with a network 218 such as the Internet or other type of computer or telephone networks. The computer 200 typically includes a memory 202, a secondary storage device 212, a processor 214, an input device 216, a display device 210, and an output device 208.

The memory 202 may include random access memory (RAM) or similar types of memory. The secondary storage device 212 may include a hard disk drive, floppy disk drive, CD-ROM drive, or other types of non-volatile data storage, and may correspond with various databases or other resources. The processor 214 may execute information stored in the memory 202, the secondary storage 212, or received from the Internet or other network 218. The input device 216 may include any device for entering data into the computer 200, such as a keyboard, keypad, cursor-control device, touch-screen (possibly with a stylus), or microphone. The display device 210 may include any type of device for presenting visual image, such as, for example, a computer monitor, flat-screen display, or display panel. The output device 208 may include any type of device for presenting data in hard copy format, such as a printer, and other types of output devices including speakers or any device for providing data in audio form. The computer 200 can possibly include multiple input devices, output devices, and display devices.

Although the computer 200 is depicted with various components, one skilled in the art will appreciate that the computer 200 can contain additional or different components. In addition, although aspects of an implementation consistent with the method for creating and managing persistent group representations for meeting are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 200 to perform a particular method.

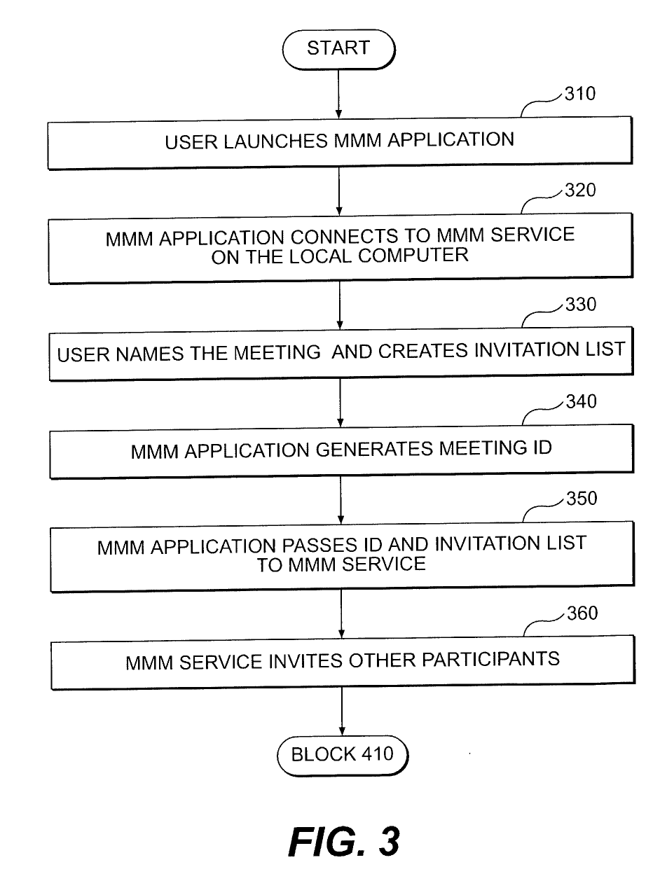

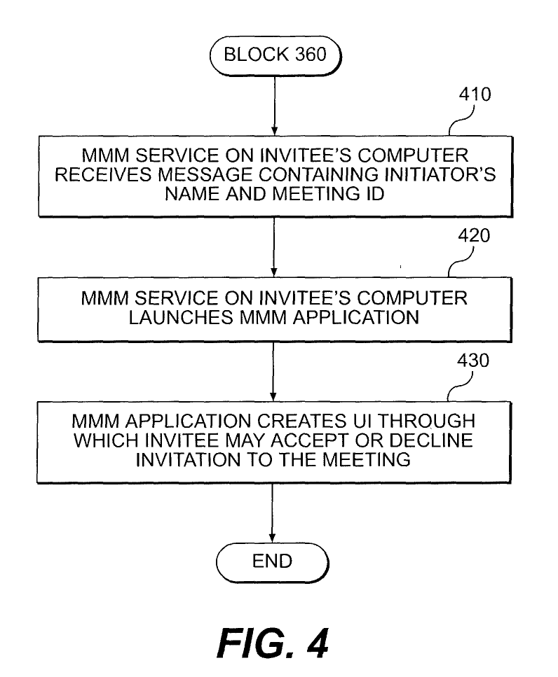

As noted above, a meeting may be initiated by a user or a computer. FIG. 3 and FIG. 4 illustrate an exemplary procedure for initiating a MMM meeting by a user. The user may be a system administrator or a meeting participant. The user (initiator) first launches a MMM application 170 (block 310). The MMM application 170 then connects to (or starts) a MMM service 160 on the local computer 200 the initiator is using (block 320). The initiator may specify a name for the meeting and a list of invitees using a UI 140 created by the MMM application 170 (block 330). The MMM application 170 then generates a meeting ID (block 340). The meeting ID may be identical to the name specified by the initiator or may have additional elements, such as time and date. Next, the MMM application 170 passes the meeting ID and invitation list to the MMM service 160 on the local computer 200, which invites other meeting participants, i.e., invitees, (block 360) by passing a message to the MMM services 160 on the invitees' computers 200.

Referring to FIG. 4, the MMM service 160 on the invitee's computer 200 receives a message that may include the initiator's name and the meeting ID (block 410). The MMM service 160 on the invitee's computer 200 then launches a MMM application 170 to provide a UI 140 with which the invitee interacts (block 420). The MMM application 170 then creates the UI 140 through which the invitee may accept or decline the invitation to the meeting (block 430).

The exemplary procedure described in FIG. 3 and FIG. 4 is for illustration only. One skilled in the art will appreciate that other software components may be used to implement the meeting initiation procedure. Similarly, the order of the steps is for demonstration only. For example, the MMM application 170 may start the MMM service 160 on the local computer 200 after the initiator has specified a meeting name. Likewise, the initiator may invite other participants before specifying a meeting ID.

In the exemplary procedure illustrated in FIG. 3 and FIG. 4, the MMM meeting is initiated by a user. Alternatively, MMM meetings may be initiated by a computer 200. For example, conference rooms may be equipped with devices that can wirelessly communicate with multiple nearby computers 200. A hosting computer 200 in a room may detect the presence of other wirelessly networked participating computers 200. A pre-established policy may specify that a MMM meeting may be initiated whenever two or more wirelessly networked computers 200 enter a room. The hosting computer 200 in the room may be programmed to send a signal, such as a Meeting-Start signal, to a corresponding software module running on the other participating computers 200. The signal may activate the MMM 100 and start a MMM meeting.

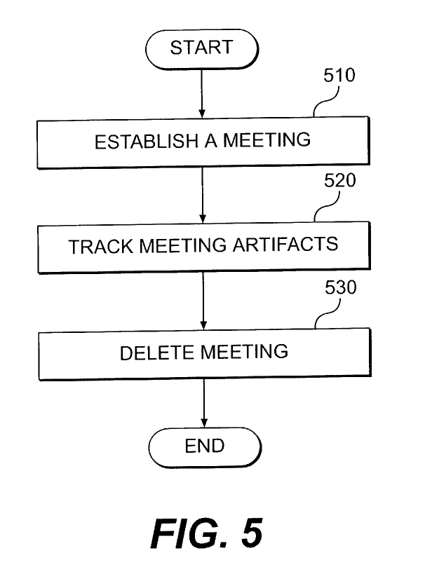

FIGS. 5-8 are flow charts illustrating an exemplary method for creating and managing persistent group representations for meetings. FIG. 5 illustrates exemplary steps of establishing a MMM meeting (block 510), tracking meeting artifacts (block 520), and deleting the MMM meeting (block 530).

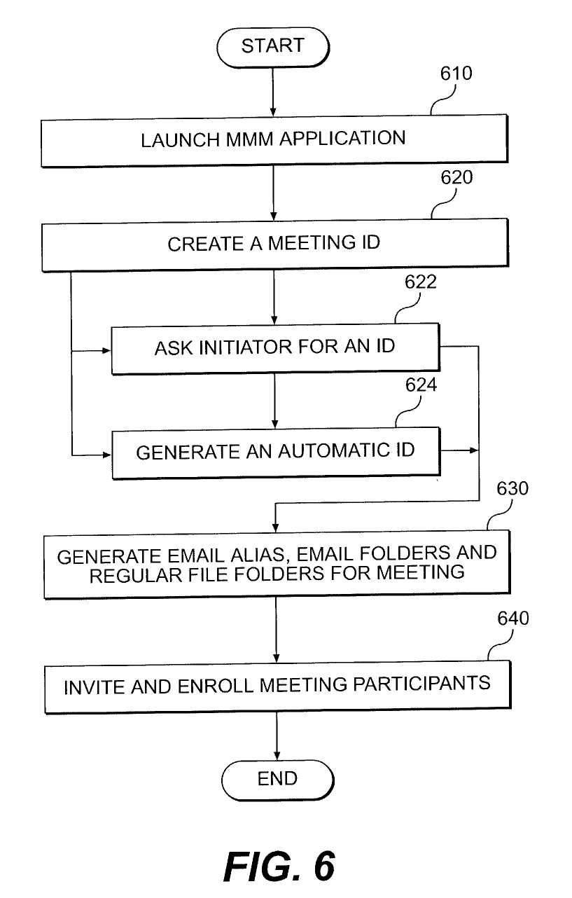

FIG. 6 illustrates exemplary steps for establishing the MMM meeting (block 510). Referring to FIG. 6, an initiator (either a user or a computer) typically launches a MMM application 170 to establish a MMM meeting (block 610). The MMM 100 then creates a meeting ID (block 620). If the initiator establishes the meeting, the MMM typically asks the initiator for a name that can be used to generate the ID (block 622). Alternatively, the MMM 100 generates an automatic ID (block 624). An exemplary scheme for generating an automatic ID is to use the meeting time, the meeting location, and/or the participants in the meeting. For example, a meeting ID based on meeting-start-time and meeting location can be: Executive-aisle;Bldg-6;3:30 PM. Alternatively or in addition to the previous scheme, the meeting group may be named using apparent subject matter of the meeting, which may be derived from documents being exchanged at the meeting. For example, if a document titled FY2002 Budget is distributed to the participants of the meeting, the MMM 100 may include the name FY2002 BudgetMeeting as all or part of the meeting ID.

Besides the meeting ID, the MMM 100 may generate by-products, such as an email alias for the MMM meeting that permits the meeting participants to easily send emails to all other participants of the meeting (block 630). The email alias name may be the same as the meeting ID or may be derived from the meeting ID. The MMM 100 may create email folders for automatic routing of email. The MMM 100 may also create regular file folders in network accessible storage for storing non-mail meeting documents.

One or more meeting participants may later rename the meeting. Once renamed, each meeting participant's computer 200 is notified of the name change and updates the local copy of the meeting appropriately. The initiator of a meeting (if a human) is typically designated by the MMM 100 as the meeting leader. The leader may have special privileges with respect to managing the meeting. For example, the MMM 100 may maintain a policy that only the meeting leader can rename or delete a meeting.

After the meeting is established, the MMM 100 invites and enrolls meeting participants (block 640). Invitation may be explicit or implicit. Explicit invitation by an initiator is described above with respect to FIG. 3 and FIG. 4. The initiator may invite other users by name. Alternatively, the initiator may specify invitees within a group such as “everyone in shipping and receiving.” Invitations may also be extended to those within a certain physical proximity, for example, “everyone on Aisle 9.”

Though attendees are typically invited at the beginning of a meeting, the meeting membership can be extended by the invited participants at any time - even after the physical meeting ends. Therefore, an absentee or supervisor who has supervision responsibility for the activity at the meeting can track the meeting documents at any time.

Inviting meeting participants provides one example of communication among different MMM services 160. The communication may be point-to-point, or it may involve a central server. Point-to-point communication is typically used by MMM services 160 on computers 200 that are in close physical proximity. For example, the initiator's computer 200 may send an invitation signal to all other computers 200 in the local area using an infrared (IR) or radio frequency (RF) local signaling protocol (IRDA® or Bluetooth®, for example). The local computers 200 that are equipped to receive such wireless transmissions and are running a MMM service 160 may then accept the invitation and participate in the meeting. Alternately, the invitation and enrollment process may be accomplished by connecting the initiator's MMM service 160 to a central MMM service 160 that redirects the invitation to other computers 200. The redirection may be accomplished in various ways. For example, invitations may be redirected based on email addresses of invitees or to all computers running a MMM service 160 in close proximity (physical or organizational) to the meeting initiator.

After an invitee accepts the invitation, the invitee is enrolled and becomes a meeting participant. A person may also be enrolled without being invited if the person or the inviting entity, such as the computer in the conference room, has sufficient privilege. In other words, the MMM 100 may have a policy of enrolling all people that bring computers 200 into a conference room for a meeting. The MMM 100 may also automatically enroll a supervisor whether the supervisor is physically present or not.

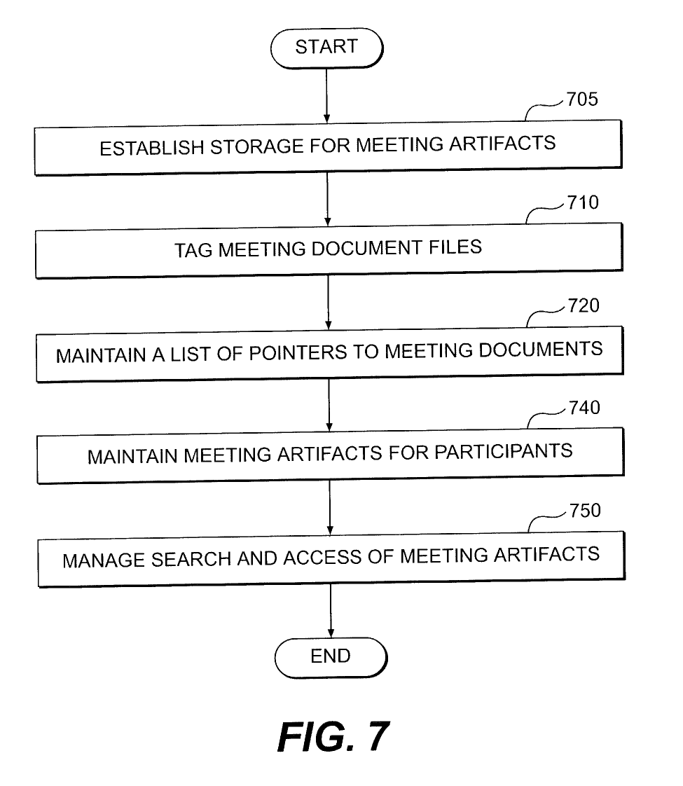

FIG. 7 illustrates exemplary steps for tracking the meeting artifacts (block 520). Upon creating a meeting ID, the MMM 100 may establish storage for the meeting artifacts (block 705). The meeting artifacts are typically stored on a network-based computer 200 that is accessible to all the participants of the meeting. Typically, only meeting participants are given privileges and permissions to access the meeting documents. Non-participants may be barred from accessing the meeting documents, or may be given read-only privileges, for example.

Next, the MMM 100 may use the meeting ID to tag documents created or used in the meeting (block 710). The tag may be added to a file to identify the file as a meeting document. The tag may also be added to emails so that specially installed email filters can route meeting emails to folders that are specially created to hold meeting related correspondence. Alternatively or in addition to tagging meeting document files, the MMM 100 may maintain a list of pointers to where the meeting documents can be found (block 720).

One of the key elements to be stored is a meeting master record, which includes a participant list, a document list, and the time and location of the meeting. The document list may contain the actual documents of the meeting, or alternatively, the location of the documents. The designated documents of the meeting may be copied to a central location, which may be the same location that stores the meeting master record. Alternatively, the documents may be kept on the network in a distributed fashion. After storage, the MMM 100 maintains the meeting artifacts for the meeting participants (block 740), and provides a user interface 140 to manage searches and accesses by the meeting participants (block 750).

In one embodiment, the user interface 140 includes an option menu 142 (also referred to as a combo-box), a text box 144, and a list control 146 (shown in FIG. 1). The option menu 142 may list all available meetings currently being managed by the MMM 100. The user can select one of the listed meetings or can type the name of a meeting ID into the text box 144. If a meeting ID is entered, the MMM 100 may then search for the named meeting. Upon finding a meeting, meeting documents are displayed in the list control 146. Attributes of the documents may also be displayed in the list control 146. Such attributes may include: creation time, time last used, initiator, and read or write privileges. Subject to access privileges that may be in effect, the user can select a document for viewing and/or editing.

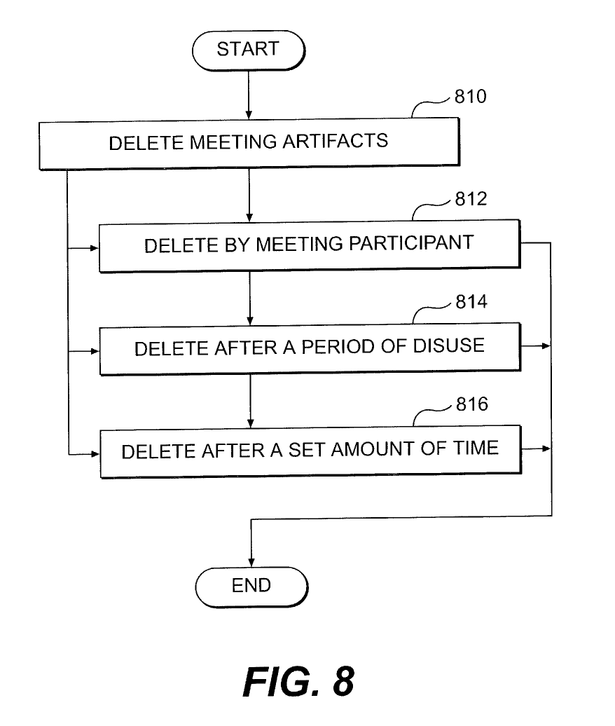

FIG. 8 illustrates exemplary methods for deleting the MMM meeting (block 530). The MMM 100 typically retains meeting artifacts until the meeting artifacts are explicitly deleted by a meeting participant (block 810, 812). Alternatively, the MMM 100 deletes the meeting artifacts after a period of disuse (block 814) or after a set amount of time (block 816). The length of time associated with the artifact retention policies can be set by default or by user intervention. Deletion initiated by the MMM 100 can optionally be confirmed by one or more meeting participants. For example, if the files associated with a MMM meeting are not used for weeks, the MMM meeting may be purged from the computers 200 of all participants, typically after confirming the pending deletion with someone designated as the meeting leader. Conversely, if a MMM meeting is heavily used at some point in its lifetime, the MMM meeting may remain extant even if dormant for long periods. However, meeting participants can always designate a MMM meeting as permanent regardless of usage pattern. Further, meeting documents need not be deleted all at once. Some documents can be retained while the less relevant once are deleted. One skilled in the art will appreciate that many other meeting artifacts and meeting retention policies can be devised.

The MMM 100 may delete meeting artifacts by literally removing a document from the storage 130. Alternatively, the MMM 100 may remove the reference to the document from the meeting record's document list.

While the method and apparatus for creating and managing persistent group representations for meeting have been described in connection with an exemplary embodiment, those skilled in the art will understand that many modifications in light of these teachings are possible, and this application is intended to cover any variations thereof.

What is claimed is:

1. A method for creating and managing persistent group representations for meetings, comprising:
establishing a meeting, comprising:
creating a meeting identification for a meeting; and
inviting and enrolling meeting participants for the meeting;
tracking meeting artifacts of the meeting, wherein the meeting artifacts include meeting documents; and
managing searches and accesses of the meeting artifacts by the meeting participants.

2. The method of claim 1, wherein the establishing step includes establishing the meeting by a user.

3. The method of claim 1, wherein the establishing step includes establishing the meeting by a computer.

4. The method of claim 1, wherein the creating step includes asking an initiator for the meeting identification.

5. The method of claim 1, wherein the creating step includes generating an automatic meeting identification.

6. The method of claim 5, wherein the automatic meeting identification is generated using one or more of meeting time, meeting location, names of the meeting participants, and a subject matter of the meeting.

7. The method of claim 1, wherein the tracking step includes tagging the meeting documents with the meeting identification.

8. The method of claim 1, wherein the tracking step includes maintaining a list of pointers to where the meeting documents are located.

9. The method of claim 1, wherein the inviting step includes explicitly inviting the meeting participants by a user.

10. The method of claim 1, wherein the inviting step includes implicitly inviting the meeting participants by a computer.

11. The method of claim 1, further comprising storing the meeting artifacts for the meeting participants.

12. The method of claim 1, further comprising generating email alias, email folders and regular file folders for the meeting, wherein the meeting artifacts can be routed automatically to the email alias, the email folders and the regular file folders.

13. The method of claim 1, further comprising renaming the meeting by one of the meeting participants.

14. The method of claim 1, further comprising deleting the meeting artifacts.

15. The method of claim 14, wherein the deleting step includes deleting the meeting artifacts by one or more of the meeting participants.

16. The method of claim 14, wherein the deleting step includes deleting the meeting artifacts after a period of disuse.

17. The method of claim 14, wherein the deleting step includes deleting the meeting artifacts after a set amount of time.

18. A meeting memory manager (MMM), comprising:
a meeting identification generator capable of generating a meeting identification for a meeting and tagging meeting artifacts with the meeting identification, wherein the meeting artifacts include meeting documents;
an enrollment and management facility capable of inviting and enrolling meeting participants for the meeting; and
a user interface that enables the meeting participants to search and access the meeting artifacts.

19. The MMM of claim 18, wherein the meeting artifacts include meeting emails and recordings of meeting proceedings.

20. The MMM of claim 18, wherein the enrollment and management facility includes a MMM service.

21. The MMM of claim 20, further comprising a MMM application that creates the user interface and interacts with the MMM service.

22. The MMM of claim 18, further comprising one or more storages capable of storing and maintaining the meeting artifacts for the meeting participants.

23. The MMM of claim 18, wherein the user interface includes an option menu, a text box and a list control.

24. The MMM of claim 18, wherein the user interface enables the meeting participants to accept an invitation to the meeting.

25. A computer readable medium providing instructions for creating and managing persistent group representations for meetings, the instructions comprising:
establishing a meeting, comprising:
creating a meeting identification for a meeting; and
inviting and enrolling meeting participants for the meeting;
tracking meeting artifacts of the meeting, wherein the meeting artifacts include meeting documents; and
managing searches and accesses of the meeting artifacts by the meeting participants.
